(19) United States
(12) Patent Application Publication
(10) Pub. No.: US 2014/0015783 A1
(43) Pub. Date: Jan. 16, 2014

(54) METHOD AND APPARATUS FOR DETECTING AN ATTACHABLE/DETACHABLE PEN

(71) Applicant: Samsung Electronics Co., Ltd, Gyeonggi-do (KR)

(72) Inventor: Jaewoong Jeon, Gyeonggi-do (KR)

(21) Appl. No.: 13/943,623

(22) Filed: Jul. 16, 2013

(30) Foreign Application Priority Data
Jul. 16, 2012 (KR) 10-2012-0077014

(51) Int. Cl. G06F 3/038

(52) U.S. Cl. CPC G06F 3/038
USPC 345/173

(57) ABSTRACT

The present disclosure relates to an apparatus for detecting insertion/detachment of E-pen. The apparatus includes a display unit including a touch screen panel (TSP) unit and an E-pen panel sensing an E-pen input, an E-pen insertion unit sensing information related to insertion of the E-pen, and a control unit controlling a power of the E-pen panel using the information related to insertion.

### CROSS-REFERENCE TO RELATED APPLICATION(S) AND CLAIM OF PRIORITY

The present application is related to and claims the benefit under 35 U.S.C. §119(a) of a Korean patent application No. 10-2012-0077014 filed on Jul. 16, 2012 in the Korean Intellectual Property Office, the entire disclosure of which is hereby incorporated by reference.

### TECHNICAL FIELD

The present disclosure relates to an apparatus having an detachable E-pen, and more particularly, to a method and an apparatus of reducing a power consumption by detecting the E-pen which is detachable.

### BACKGROUND

Generally, as an input, method for a computer or a portable terminal including a tablet personal computer (PC) and a smart phone, a capacitive or pressure-sensitive touch input method responding to a touch screen panel (TSP) have been widely used as well as a hard key input method. In addition, a digitizer input method has also been used as one of the input method for computer. The digitizer, which is a device for reading a coordinate, performs various operations using the input coordinate.

### SUMMARY

To address the above-discussed deficiencies of the prior art, it is a primary object to provide a method and an apparatus of reducing an unnecessary power consumption when an E-pen is not used by sensing the E-pen which is attachable/detachable, and controlling a power of E-pen panel (or E-pen panel) depending on whether the E-pen is inserted or detached.

In accordance with an aspect of the present disclosure, an apparatus having a structure of detecting insertion/detachment of E-pen, includes a display unit including a touch screen panel (TSP) unit and an E-pen panel sensing an E-pen input, an E-pen insertion unit sensing information related to insertion of the E-pen, and a control unit configured to control a power of the E-pen panel based on detection of the insertion and/or detachment.

In accordance with another aspect of the present disclosure, an E-pen attachable to an apparatus for detecting insertion and/or detachment of E-pen, includes an contact operation generating unit which generates a magnetic field signal sensed by an insertion and/or detachment operation sensor sensing an insertion/detachment operation of the E-pen in the apparatus.

In accordance with another aspect of the present disclosure, a method of reducing a power consumption using a structure for detecting insertion and/or detachment of E-pen, includes sensing an insertion and/or detachment operation of an E-pen, determining whether the sensed operation is an insertion operation or detachment operation of the E-pen, and controlling a power of the E-pen panel according to a result of the determination.

Before undertaking the DETAILED DESCRIPTION OF THE DISCLOSURE below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high-level block diagram schematically illustrating a configuration of a terminal according to an exemplary embodiment of the present disclosure;

FIG. 2 illustrates an apparatus having a structure for detecting insertion/detachment of E-pen;

FIGS. 3A and 3B are diagrams illustrating an apparatus having a structure for detecting the operation and the state of insertion/detachment of E-pen;

FIG. 4 is a flowchart illustrating a method of reducing a power consumption by using a structure for detecting insertion/detachment of E-pen;

FIG. 5 is a flowchart illustrating an input process of a user in addition to the method of reducing a power consumption by using a structure for detecting insertion/detachment of E-pen; and

FIGS. 6A and 6B are exemplified diagrams illustrating a notification of input request for a user.

### DETAILED DESCRIPTION

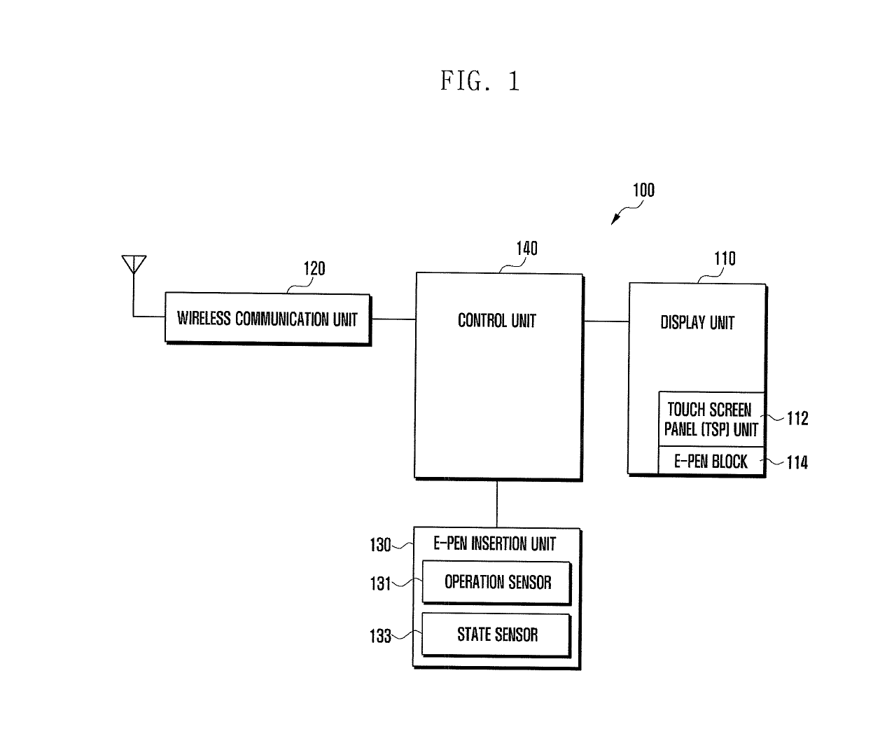

FIGS. 1 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electric devices. Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

Hereinafter, exemplary embodiments of the present disclosure will be described in detail with reference to the accompanying drawings.

As an example of the input for the digitizer, in the case of using a pen (e.g., stylus) having a micro sized metal coil inserted to a contact part, an electromagnetic induction occurs in the coil when an end portion of the pen approaches the digitizer, and then, the digitizer senses the electromagnetic induction and recognizes this as a real pen. For this disclosure, a stylus pen for input on a touch screen is referred to an E-pen. In some embodiment, an E-pen can include a metal coil at the end.

When the digitizer technology can be applied to the tablet PC or the smart phone, such that products which are manufactured by combining the TSP with a digitizer input type using the electromagnetic induction have been used. When, for example, a liquid crystal display (LCD) is turned on, power is simultaneously supplied to a power unit relating to the E-pen in addition to the TSP, such that a power is unnecessarily consumed in a circuit unit relating to the E-pen, even when a user does not use the E-pen. As a result, a waiting time and a using time of the portable terminal or the computer are reduced.

An apparatus for detecting insertion/detachment of an E-pen according to an embodiment of the present disclosure can be any electronic products or any display devices supporting an E-pen. For example, E-pen can include a tablet PC, a slate PC, a note PC, a smart phone, or the like which are capable of recognizing the E-pen as an input means. However the present disclosure is not limited thereto.

Hereinafter, embodiments of the present disclosure will be described in detail with reference to the accompanying drawings. In describing the present embodiment, a description that is well known in the art to which the present disclosure pertains and is not directly related to the present disclosure will be omitted.

FIG. 1 is a block diagram schematically illustrating a configuration of a terminal according to an exemplary embodiment of the present disclosure.

Referring to FIG. 1, an apparatus of the present disclosure may include a control unit 140, a display unit 110, a wireless communication unit 120, and an E-pen insertion unit 13.

The display unit 110 can also include a touch screen panel (TSP) 112 for displaying an output of the apparatus and an E-pen panel 114 serving as an input unit which receives input through an E-pen.

The TSP 112 is mounted on a front surface of the display unit 110, and generates a touch event in response to a touch gesture of user for the TSP 112 to send to the control unit 140. Accordingly, the control unit 140 senses the touch gesture of the user from the touch event input from the TSP unit 112, may control the above configurations in response to the sensed touch gesture.

Here, the touch gesture can be divided into a touch, a tap, a long tap, a drag, and a sweep. The touch is a touch gesture that the user presses any one point of a screen. The tap is a touch gesture of touching-off, that is, dropping a finger from the corresponding point without moving of the finger after touching any one point of the screen. The long tap is a touch gesture of touching-off the finger from the corresponding point without moving of the finger after touching relatively longer than the tap. The drag is a touch gesture of moving the finger in a certain direction in a state in which the user touches any one point of the screen. The sweep, also called a flick, is a touch gesture that the finger is rapidly moved to bounce on the screen and is then touched off.

Meanwhile, a resistive type touch panel, a capacitive type touch panel, an electromagnetic induction type touch panel, a pressure type touch panel, and the like can be applied to the TSP unit 112.

The E-pen panel. 114 has a sheet form that exists separately from the TSP unit 112, and corresponds to an input unit recognizing the input by E-pen such as a digitizer or the like.

The E-pen panel 114 is a configuration to which a position of X and Y can be input. Therefore, the user can input using the E-pen on the sheet coupled with the display unit having a plane of a rectangular shape. When the user moves the E-pen, the E-pen panel 114 senses coordinate information to send to control unit 140, and when the control unit 140 receives the information, it sends a corresponding command.

The E-pen panel 114 disassembles an image of photographs or a line of printing type into an electric bit to store (memory) to the control unit 140. Then, when it is necessary, the original image is restored. The E-pen panel 114 can be used when inputting figure data to the computer or amending figures on a graphic display screen.

The digitizer can be suggested as an example of the E-pen panel 114. The digitizer can be divided into an automatic digitizer and a manual digitizer depending on the structure, in the manual digitizer, there is a country scheme that reads a position by using a rotary encoder or a linear scale and a precursor scheme that reads a position by using a cursor. However, the technical features of the present disclosure are not limited thereto.

The display unit 110 converts and displays digital data received from the control unit 140 into analog data under control of the control unit 140. That is, the display unit 110 can display various screens according to the usage the apparatus, for example, a lock screen, a home screen, an application (hereinafter referred to ‘App’) execution screen, a menu screen, a keypad, a thumbnail list, and the like. The lock screen means an image which is displayed when the screen of the display unit 110 is turned on

When the touch gesture or the input by E-pen for unlocking is sensed, the control unit 140 can change a displayed image from the lock screen to the home screen, the app execution screen, or the like. The home screen means an image including a plurality of app icons corresponding to a plurality of apps, respectively. When any one of the plurality of app icons is selected by the user, the control unit 140 executes the corresponding app. In this case, the display unit 110 displays the execution screen of the selected app. In addition, under control of the control unit 140, the display unit 110 displays any one of the screens as a main screen and another screen as a sub screen can be displayed to overlap with the main screen. For example, the display unit 110 displays the app execution screen and can display the keypad or the thumbnail list on the app execution screen. All displayed screen can be controlled by the E-pen as well as the touch gesture.

A liquid crystal display (LCD), an organic light, emitted diode (OLED), an active matrix organic light emitted diode (AMOLED), and the like can be used as the display unit 110 with a flat display panel type. However, the display unit 110 of the present disclosure is not limited thereto.

Meanwhile, the communication unit 120 supports a communication function of the apparatus. The communication unit 120 can be added in the case in which the apparatus is manufactured as a terminal supporting the communication function. Therefore, in the case in which the apparatus of the present disclosure does not support the communication function, the communication unit 120 can be omitted when configuring the apparatus. Meanwhile, the communication unit 120 can be prepared as a mobile communication module type so as to support the communication function of the apparatus, particularly, the mobile communication function. The communication unit 120 forms a communication channel with a mobile communication system to support a transmitting and receiving of a signal for performing the mobile communication function of the terminal 100.

Next, the E-pen insertion unit 130, which is a kind of a pouch in which the E-pen 200 is detached or inserted, is inserted to the apparatus in an embedded type or an external type. Since the E-pen 200 is discomfort to hold and has a risk of losing, the E-pen insertion unit 130 serves to keep the E-pen 200 together with the apparatus. The E-pen insertion unit 130 senses an insertion/detachment operation and state of E-pen 200. The E-pen insertion unit 130 includes an operation sensor 131 capable of sensing the insertion/detachment operation of E-pen 200. Furthermore, the E-pen insertion unit 130 can further include a state sensor 133 capable of sensing the insertion/detachment state of E-pen 200.

The operation sensor 131 can sense the insertion operation and detachment operation of the E-pen 200 by using a magnetic field. In addition, when the insertion of the E-pen 200 is completed to stop the insertion operation, the operation sensor 131 can sense the state in which the E,-pen 200 is inserted. In contrast, when the detachment of the E-pen 200 is completed to stop the detachment operation, the operation sensor 131 can sense the state in which the E-pen 200 is detached. The information associated with the insertion operation, the detachment operation, the insertion state, and the detachment state of the E-pen sensed through the operation sensor 131 are transmitted to the control unit 140 as an electric signal.

The state sensor 133 can sense the insertion state and detachment state of the E-pen 200 by using an electrical contact. The state sensor 133 senses the state in which the E-pen 200 is inserted when sensing the electrical contact. Otherwise, the state sensor 133 senses the state in which the E-pen 200 is detached.

The control unit 140 can control an overall operation of the apparatus and a flow of signal between inner configurations and perform the functions for processing the data. The control unit 140 can control the power supplied from the battery into the inner configurations, and execute various applications stored in a program area. Particularly, the operation sensor 131 and the state sensor 133 inside of the E-pen insertion unit 130 of the present disclosure sense the E-pen insertion/detachment operations or the E-pen insertion/detachment states by using the magnetic field or the electrical contact. Here, the sensed information on the insertion and detachment operations or the insertion and detachment states of the E-pen 200 is transmitted to the control unit 140 as the electric signal relevant to corresponding operation and state. The control unit 140 determines whether the information corresponding to the received signal corresponds to any operation and state of the operation and state of the E-pen. That is, the control unit 140 can determine whether the E-pen is being inserted or being detached or whether the E-pen is in inserted state or detached state from the received signal. In addition, the control unit 140 serves to control the power supplied to the E-pen panel 114 by using the determined result.

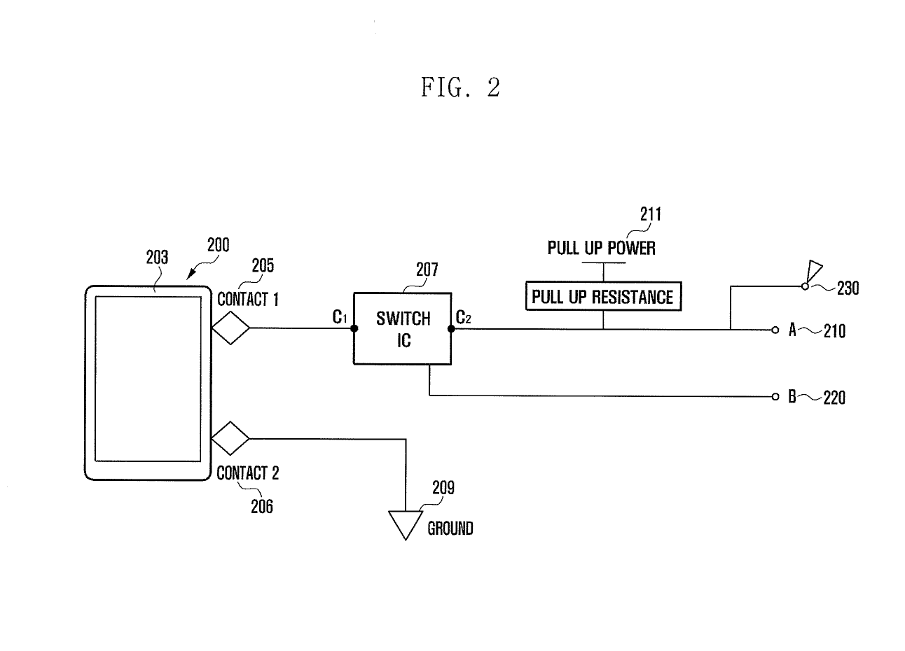

FIG. 2 is a diagram illustrating an apparatus for detecting insertion/detachment of E-pen according to an exemplary embodiment of the present disclosure.

FIG. 2 illustrates a state in which an E-pen 200 is inserted in the E-pen insertion unit 130, and corresponds to a plane diagram viewed from top of an apparatus in the state in which the E-pen 200 is inserted. In addition, although not shown, FIG. 2 is a diagram illustrating an operation of a state sensor 133 included in the E-pen insertion unit 130. The state sensor 133 can include CONTACT 1 205, CONTACT 2 206, SWITCH IC 207 and GROUND 209 of FIG. 2. The control unit 140 is connected with a node A 210 and a node 230, and a node B 220 is connected to the display unit 110. A signal transmitted by the node B 220 is received in the E-pen panel 114 through the display unit 110.

In FIG. 2, the E-pen 200 can include a contact part contacting to the E-pen insertion unit 130 in a form of outer ring. The outer ring 203, preferably, corresponds to a conductor and encloses the E-pen 200. The outer ring 203 can enclose only a portion of the E-pen and can also enclose the whole surface of the E-pen. In addition, unlike FIG. 2, the E-pen 200 and the outer ring 203 of the E-pen don't necessarily have a rectangular shape but can have various shapes.

When the outer ring 203 of the E-pen 200 contacts the CONTACT 1 205, that is, the E-pen 200 is inserted to the E-pen insertion unit 130, the outer ring 230 is also contacted the CONTACT 2 206 connected to the GROUND 209 due to the physical structure. The SWITCH IC 207 can be a configuration included in the state sensor 133. The SWITCH IC 207 connects the node Cl with C2. Since the SWITCH IC 207 is connected with the GROUND 209 when the E-pen 200 is inserted, insertion of the E-pen is informed to the control unit 140 through the node A 210. Therefore, the control unit 140 can determine the insertion state. The E-pen insertion unit 130 sends the electric signal to the control unit 140 through the node A 210 to inform the insertion state of the E-pen to the control unit 140. The electric signal sent to the control unit includes the E-pen insertion state information. The control unit 140 receives the signal and transmits a command signal of turning off the power to the SWITCH IC 207 through the node 230. Accordingly, the SWITCH IC 207 turns the power of the E-pen panel 114 off through the node B 220.

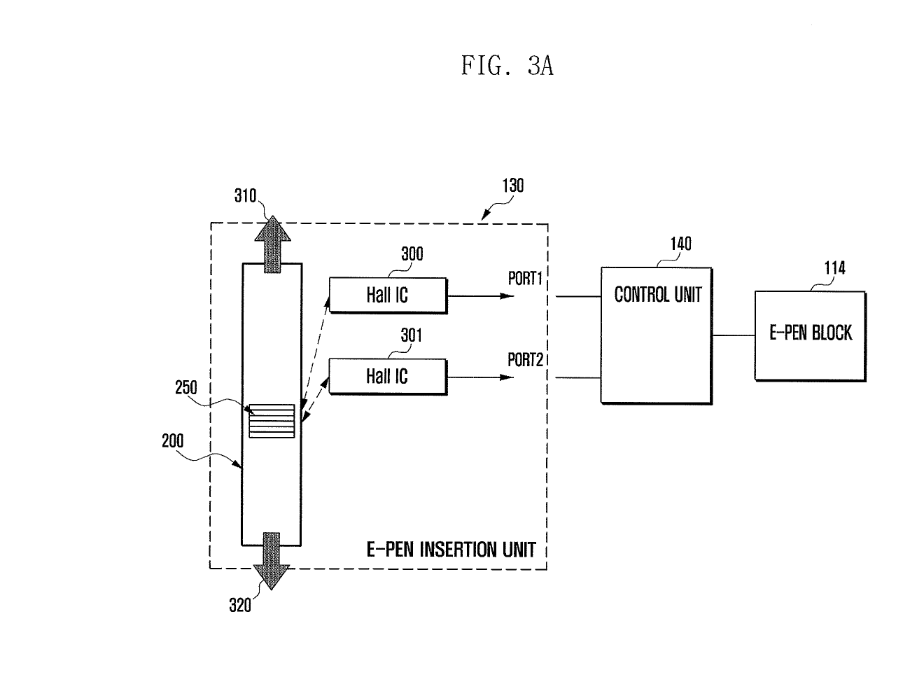

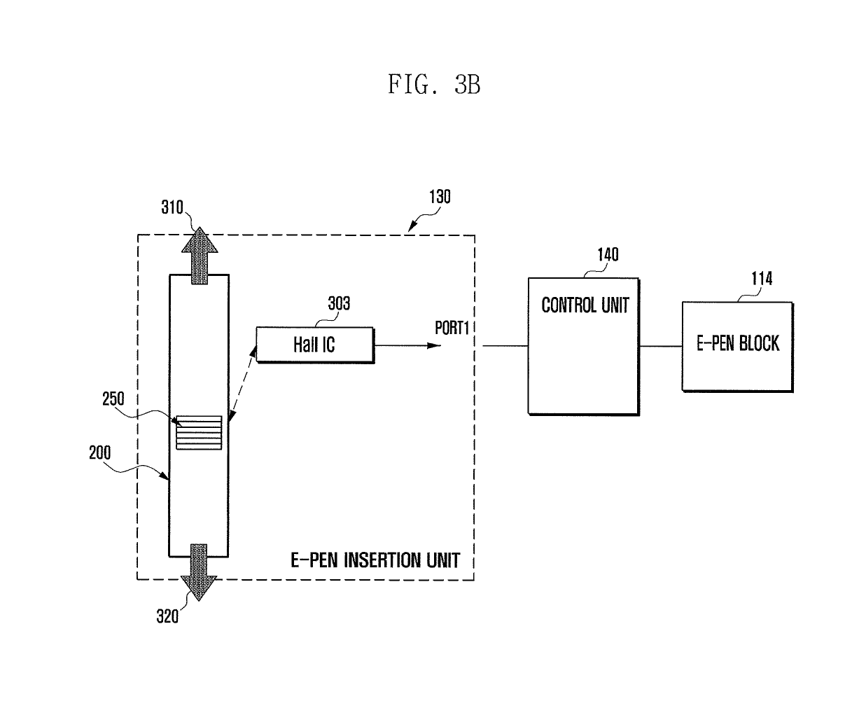

Meanwhile, even when the outer ring 203 of the E-pen does not exist, according to the exemplary embodiment of the present disclosure which will be described with reference to FIGS. 3A and 3B, the inside of the E-pen 200 includes a magnet or hall IC. In addition, an operation sensor 131 senses a magnetic field between the magnet and the hall IC to transmit information of the insertion/detachment operation or information of the insertion/detachment state to the control unit 140. The control unit 140 can control the power of the E-pen panel 114 by determining such information.

FIGS. 3A and 3B are diagrams illustrating an apparatus for detecting insertion/detachment of E-pen according to another exemplary embodiment of the present disclosure.

FIG. 3A illustrates an example of the state in which the E-pen 200 is inserted in the E-pen insertion unit 130. Particularly, although not shown, an inner configuration of the E-pen insertion unit 130 shown as a dotted line is a diagram for describing a function of the operation sensor 131.

The E-pen 200 according to another exemplary embodiment of the present disclosure is used for an apparatus having an E-pen insertion/detachment recognition structure, and includes an operation signal generating unit 250 which generates a magnetic field signal sensed by the operation sensor 131 for the E-pen insertion/detachment. Here, the operation signal generating unit 250 can be a magnet internally or externally inserted to the E-pen 200.

The operation sensor 131 for the E-pen insertion/detachment can generate the operation information by sensing the operation signal generated through the operation signal generating unit 250 when the E-pen is being inserted or detached. In addition, the operation sensor 131 can include at least one of hall IC 300 and 301 as shown in FIG. 3A. That is, as the operation sensor 131 of the present disclosure, a magnetic field sensor such as the hall. IC can be used. However, the hall IC is just an example and the present disclosure is not limited to the kind of the magnetic field sensor.

In the case in which the magnetic field sensor such as the hall. IC is used as the operation signal generating unit 250 included in the inside of the E-pen, the magnet can be included in the operation sensor 131 for the insertion/detachment.

First, it will be described that the operation sensor 131 inside of the E-pen insertion unit 130 includes two or more hall IC 300 and 301. The control unit 140 can determine whether the E-pen is inserted or detached by sensing an order, an intensity, a direction, and the like in which the operation signal generating unit 250 closes to or goes away from the hall IC 300 and 301. The operation sensor 131 converts the signal sensed by the hall IC 300 and hall IC 301 into an electric signal and transmits respective electric signals to the control unit 140 through PORT 1 and PORT 2 of the E-pen insertion unit 130. The control unit 140 compares the signal received from both PORTs to determine whether the E-pen is inserted or detached. The electric signal includes the operation information on the insertion/detachment of E-pen 200. The control unit 140 receives the operation information and determines whether the operation information indicates the insertion operation of E-pen to control the power of the E-pen panel 114.

More specifically, it is assumed that the operation that the E-pen 200 is being inserted to the E-pen insertion unit 130 is called operation 310, and the operation that the E-pen 200 is being detached from the E-pen insertion unit 130 is called operation 320.

First, in the operation 310, the E-pen 200 enters from outside of the E-pen insertion unit 130 into the E-pen insertion unit 130. Since the operation signal generating unit 250 of the E-pen 200 is a magnetic substance, the hall IC 301 and the operation signal generating unit 250 form a magnetic field. The hall IC 301 senses that the strength of the magnetic field increases as the operation signal generating unit 250 approaches. At this time, another hall IC 300 senses the magnetic field weaker than that of the Hall IC 301, then gradually stronger magnetic field senses. Thus, each of the hall IC 300 and 301 can sense a direction in which the magnetic field increases. Each of the hall IC 300 and 301 converts the strength and direction of the sensed magnetic field into the electric signal. The hall IC 300 transmits the electric signal to the control unit 140 through the port 1 while the hail IC 301 transmits the electric signal to the control unit 140 through the port 2. The control unit 140 compares and analyzes the signal receiving through two ports to determine that the E-pen 200 is being inserted.

When the operation signal generating unit 250 fully enters into the E-pen insertion unit 130 so that the insertion is completed, the hall IC 300 senses the magnetic field stronger than that of the hall IC 301. In this case, since the operation signal generating unit 250 does not move, a plurality of the hall IC 300 and 301 sense that the direction of the magnetic field is not changed. Each of the hall IC 300 and 301 converts certain state information on the strength and direction of the sensed magnetic field into the electric signal. The hall IC 300 transmits the electric signal to the control unit 140 through the port 1 while the hall IC 301 transmits the electric signal to the control unit 140 through the port 2. The control unit 140 compares and analyzes the signal receiving through two PORTs to determine that the E-pen 200 is in the insertion state.

Next, in the operation 320, the E-pen 200 leaves from the inner portion of the E-pen insertion unit 130 to outside of the E-pen insertion unit 130 Since the operation signal generating unit 250 of the E-pen 200 is a magnetic substance, the hall IC 301 and the operation signal generating unit 250 form a magnetic field. The hall IC 301 senses that strength of the magnetic field decreases as the operation signal generating unit 250 goes away. At this time, another hall IC 300 senses the magnetic field stronger than the magnetic field sensed by the hall IC 301, and then, senses that the magnetic field gradually becomes weaker. Through this, each of the hall. IC 300 and 301 can sense the direction in which the magnetic field decreases. Each of the Hall IC 300 and 301 converts the strength and direction of the sensed magnetic field into the electric signal. The hall IC 300 transmits the electric signal to the control unit 140 through the PORT 1 while the hall IC 301 transmits the electric signal to the control unit 140 through the PORT 2. The control unit 140 compares and analyzes the signal receiving through two PORTs to determine that the E-pen 200 is being detached.

When the operation signal generating unit 250 fully leaves from the E-pen insertion unit 130 to complete the detachment, the hall IC 300 rarely senses the magnetic field. At the very moment the operation signal generating unit 250 leaves from the E-pen insertion unit 130, the hall IC 301 senses the weak magnetic field. After the detachment is completed, the movement of the operation signal generating unit 250 is not sensed. Each of the hall IC 300 and 301 converts the information on the strength of the magnetic field sensed into the electric signal. The hall IC 300 transmits the electric signal to the control unit 140 through the PORT 1 while the hall IC 301 transmits the electric signal to the control unit 140 through the PORT 2. The control unit 140 compares and analyzes the signal receiving through two PORTs to determine that the E-pen 200 is in the detachment state.

FIG. 3B illustrates an example of the state in which the E-pen 200 is inserted into the E-pen insertion unit 130, similar to FIG. 3A. FIG. 3B is a diagram describing an example structure of recognizing the operation and state of insertion/detachment of E-pen in the case in which the E-pen insertion unit 130 includes one hall IC 303.

When one hall IC 303 is included in the operation sensor 131, the control unit. 140 senses the strength, direction, and the like of the magnetic field to determine whether the operation signal generating unit 250 closes to or goes away from the hall IC 303. The operation sensor 131 senses the strength, direction, and the like of the magnetic field and converts the sensed signal into the electric signal to transmit to the control unit 140 through PORT 1 of the E-pen insertion unit 130. The electric signal includes the insertion/detachment operation information of the E-pen 200. The control unit 140 which received the operation information determines whether the E-pen is inserted and controls the power of the E-pen panel 114.

More specifically, it is assumed that the operation that the E-pen 200 is being inserted to the E-pen insertion unit 130 is called operation 310 and the operation that the E-pen 200 is being detached from the E-pen insertion unit 130 is called operation 320.

First, in the operation 310, the E-pen 200 enters from outside of the E-pen insertion unit 130 into the E-pen insertion unit 130. Since the operation signal generating unit 250 of the E-pen 200 is a magnetic substance, the hall IC 303 and the operation signal generating unit 250 form a magnetic field. The Hall IC 303 senses that strength of the magnetic field increases as the operation signal generating unit 250 approaches. Thus, the Hall IC 303 can sense the direction in which the magnetic field increases. In addition, depending on a position of the operation signal generating unit 250 on the E-pen 200, the direction of the magnetic field in which the hall IC 303 senses during the insertion operation can change. The hall IC 303 converts the strength and direction of the sensed magnetic field into the electric signal. The hail IC 303 transmits the electric signal to the control unit 140 through the PORT 1. The control unit 140 analyzes the signal receiving through the port 1 to determine that the E-pen 200 is being inserted.

When the operation signal generating unit 250 fully enters into the E-pen insertion unit 130 to complete the insertion, the hall IC 303 senses the magnetic field as a certain strength and a certain direction. In this case, since the operation signal generating unit 250 does not move, one hall IC 303 converts strength information of the sensed magnetic field and certain state information of direction of the magnetic field into the electric signal. The hall IC 303 transmits the electric signal to the control unit 140 through the port 1. The control unit 140 analyzes the signal receiving through the port 1 to determine that the E-pen 200 is in a insertion state.

Next, in the operation 320, the E-pen 200 leaves from the inner portion of the E-pen insertion unit 130 to outside of the E-pen insertion unit 130. Since the operation signal generating unit 250 of the E-pen 200 is a magnetic substance, the hall IC 303 and the operation signal generating unit 250 form a magnetic field. The hall IC 301 senses that strength of the magnetic field decreases as the operation signal generating unit 250 goes away. The hall IC 303 senses a direction in which the strength of the magnetic field decreases as the direction of the magnetic field. The hall IC 303 converts the decrease of strength of the sensed magnetic field and the change of direction of the sensed magnetic field into an electric signal. The hall IC 303 transmits the electric signal to the control unit 140 through the port 1. The control unit 140 analyzes the signal receiving through the PORT 1 to determine that the E-pen 200 is being detached.

When the operation signal generating unit 250 fully leaves from the E-pen insertion unit 130 to complete the detachment, the hall IC 300 rarely senses the magnetic field. At the very moment the operation signal generating unit 250 leaves from the E-pen insertion unit 130, the hall IC 301 senses a weak magnetic field. After the detachment is completed, the movement of the operation signal generating unit 250 is not sensed. The hall IC 303 converts the information on the strength of the sensed magnetic field into the electric signal. The hall IC 303 transmits the electric signal to the control unit 140 through the port 1. The control unit 140 analyzes the signal receiving through the PORT 1 to determine that the E-pen 200 is detached.

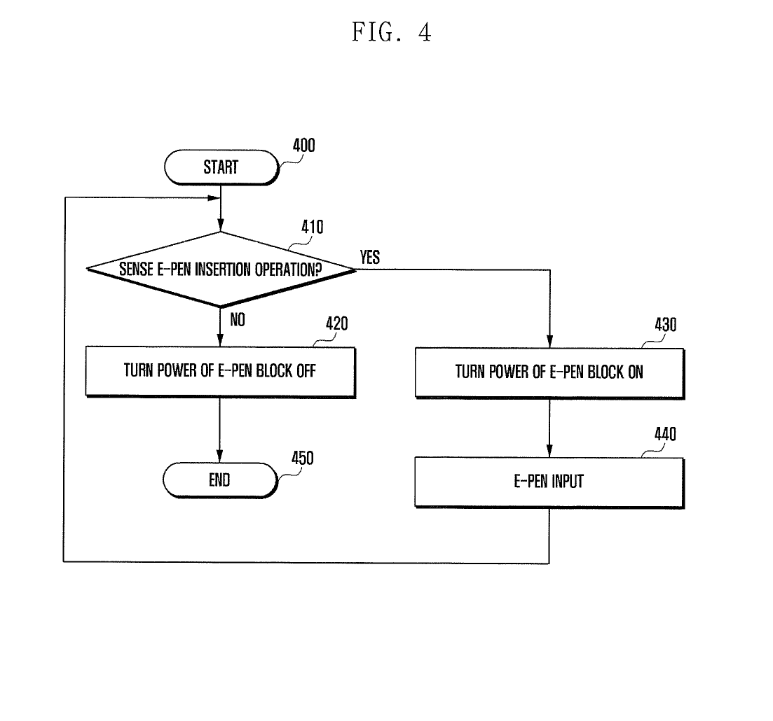

FIG. 4 is a flowchart illustrating a method of reducing a power consumption by using a structure for detecting insertion/detachment of E-pen according to an exemplary embodiment of the present disclosure

Referring to FIG. 4, an insertion or detachment operation of an E-pen 200 is started at step 400. That is, the E-pen 200 can start the detachment operation in the inserted state or start the insertion operation in the detached state at step 400. Meanwhile, an operation sensor 131 can sense an insertion state and a detachment state which the insertion and detachment operations are completed as well as the insertion and detachment operations. In addition, an E-pen insertion unit. 130 can further include a state sensor 133, and the state sensor 133 senses the insertion or detachment state of the E-pen 200. Therefore, a method of reducing a power consumption described below can be applied to the case in which the control unit 140 senses the insertion state as well as to the case in which a control unit 140 senses the insertion operation through the operation sensor 131. Further, the method of reducing the power consumption described in FIG. 4 can also be applied to the case in which the control unit 140 senses the insertion state through the state sensor 133.

The control unit 140 determines whether the E-pen insertion operation is sensed step 410. When the insertion operation of the E-pen 200 is sensed by the operation sensor 131 inside of the E-pen insertion unit 130, the operation sensor 131 converts the E-pen insertion operation into a corresponding electric signal to transmit to the control unit 140. The control unit 140 which received the electric signal senses that the E-pen 200 is being inserted through the received signal. When the control unit 140 senses the insertion operation of the E-pen 200, the control unit 140 controls a power of an E-pen panel 114 to be a turn-off state step 420. Likewise, when the control unit 140 senses that the E-pen 200 is in insertion state through the operation sensor 131 or the state sensor 133, the same control can be applied as above-mentioned.

On the other hand, at step 410, the control unit 140 can sense that the E-pen 200 is being detached or in detachment state, as a result of determining whether the E-pen insertion operation is sensed. When the detachment operation of the E-pen 200 is sensed by the operation sensor 131, the operation sensor 131 converts the sensed E-pen detachment operation into a corresponding electric signal to transmit to the control unit 140. The control unit 140 which received the electric signal determines that the E-pen 200 is being detached, from the received signal. When the control unit 140 determines the detachment operation of the E-pen 200, the control unit 140 controls the power of the E-pen panel 114 to be on-state step 430. Likewise, when the control unit 140 senses that the E-pen 200 is in detachment state through the operation sensor 131 or the state sensor 133, the same control can be applied as above-mentioned.

When the power of the E-pen panel 114 is turned on, the E-pen panel 114 can recognize an input of the E-pen 200, so that a display unit 110 can receive a user input by executing an app associated with the E-pen panel 114 step 440. When an input work is completed, the control unit 140 determines that the insertion operation of the E-pen is sensed step 410.

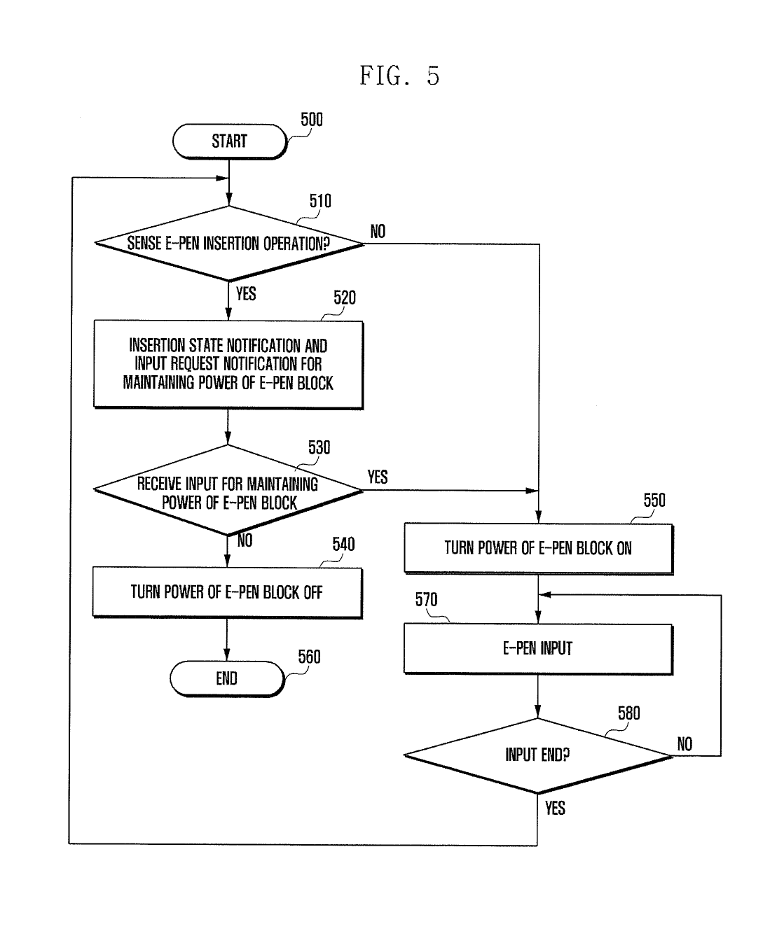

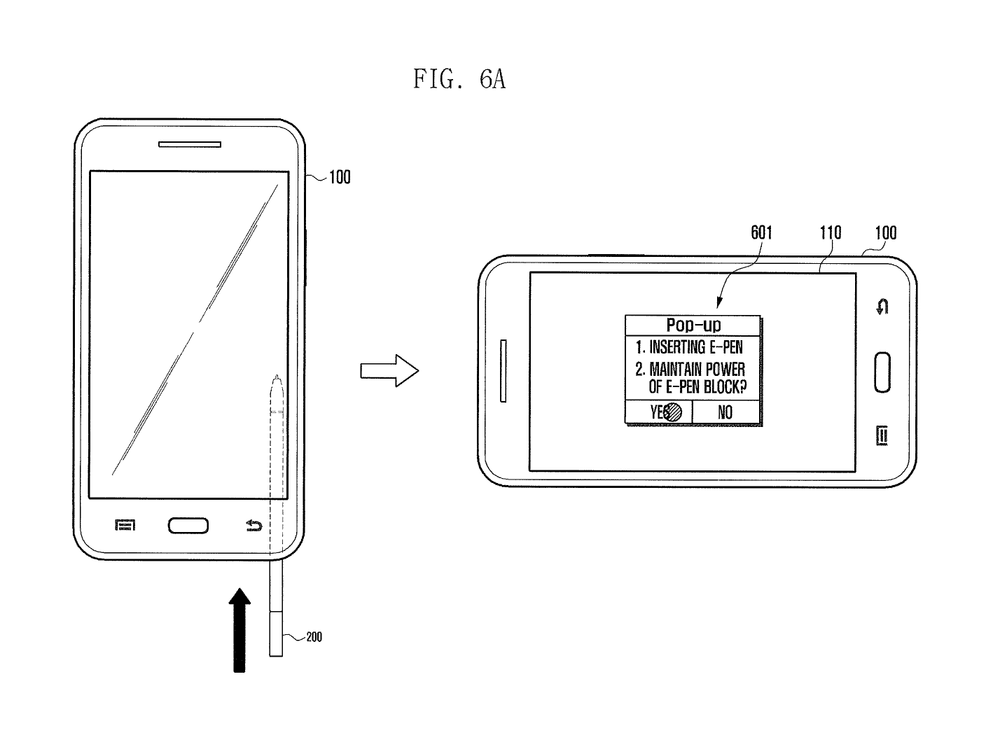

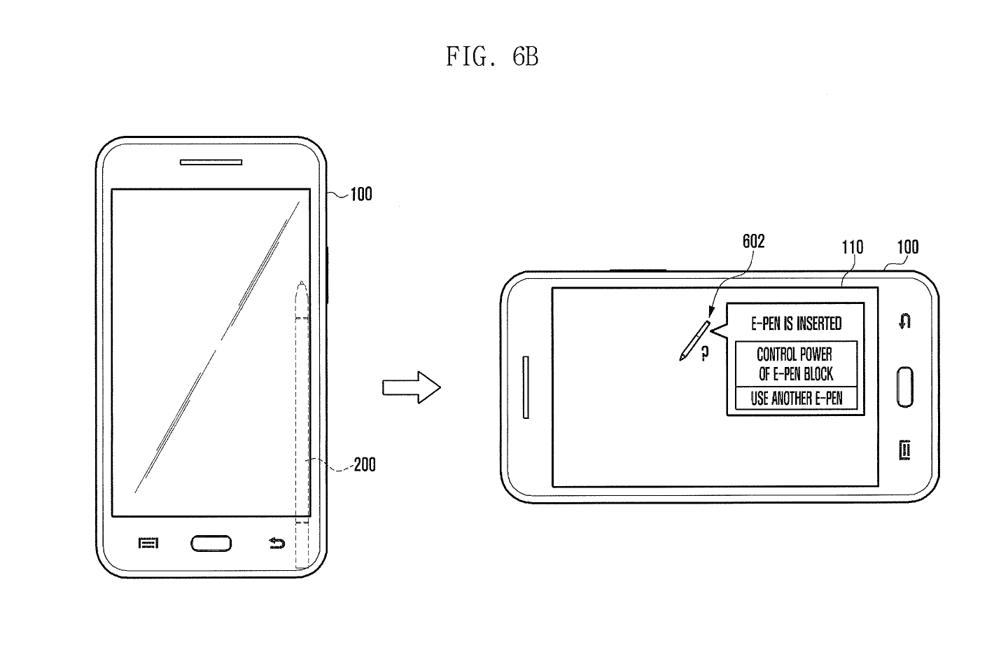

Hereinafter, referring to FIGS. 5, 6A and 6B, the method of reducing a power consumption by using a structure for detecting insertion/detachment of E-pen will be described.

FIG. 5 is a flowchart illustrating a method of reducing a power consumption by using a structure for detecting insertion/detachment of E-pen according to another embodiment of the present disclosure, and FIGS. 6A and 6B are diagrams illustrating an input, request to a user for maintaining a power.

Referring to FIG. 5, an insertion or detachment operation of an E-pen 200 is started step 500. That is, the detachment operation can be started during the E-pen insertion operation, or the insertion operation can be started in a state in which the E-pen 200 is detached.

The control unit 140 determines whether the E-pen insertion operation is sensed at step 510. First, it will be described that the control unit 140 senses the insertion operation of the E-pen. For example, the upper drawing of FIG. 6A illustrates the insertion operation that the E-pen 200 is inserted into a terminal 100 having a structure for detecting insertion/detachment of E-pen. Although not shown in drawing, the E-pen 200 is inserted into the embedded or external E-pen insertion unit 130 provided in the lower portion of the terminal 100. When the insertion operation of the E-pen 200 is sensed by the operation sensor 131 inside of the E-pen insertion unit 130, the operation sensor 131 converts the sensed E-pen insertion operation into corresponding electric signal to transmit to the control unit 140. The control unit 140, which received the electric signal, determines that the E-pen 200 is being inserted by the received signal.

Meanwhile, an operation sensor 131 can sense an insertion/detachment state in which the insertion/detachment operation is completed as well as the insertion/detachment operation. In addition, an E-pen insertion unit 130 can further include a state sensor 133, and the state sensor 133 senses the insertion or detachment state of the E-pen 200.

Therefore, a method of reducing a power consumption described in FIG. 5 can be applied to the case that the control unit 140 senses the insertion state as well as the case that the control unit 140 senses the insertion operation through the operation sensor 131 at step 510.

Further, the method of reducing the power consumption described in FIG. 5 can also be applied to the case that the control unit 140 senses the insertion state through the state sensor 133. When the control unit 140 senses the insertion operation of the E-pen 200, which corresponds to a process of inserting to the E-pen insertion unit 130 after user uses the E-pen 200, and thus, the power of the E-pen panel 114 is in the on-state. The display unit 110 can display the information that the E-pen 200 is in a insertion state and a user input request message for maintaining the power of the E-pen panel 114 at step 520.

In order to receive the user input, the display unit 110 can request an input to user by displaying a pop-up window as shown in the lower portion of FIG. 6A. The pop-up window shown in the lower portion of FIG. 6A notifies user of the information that the E-pen 200 is being inserted and requests user input for maintaining the power of the E-pen panel 114. When the input that the power of the E-pen panel 114 is maintained is received from user even when the E-pen 200 is inserted to the E-pen insertion unit 130, the control unit 140 maintains the power of the E-pen panel 114 in the on-state. Therefore, even when user uses a basic E-pen 200 provided in the terminal 100, the control unit 140 maintains the power of the E-pen panel 114, thereby making it possible to sense an input of a second E-pen which has a different type. The exemplary embodiment of the present disclosure can be implemented in various schemes(e.g., drawing of the lower portion of FIG. 6B) such as a symbol, an icon, and a dynamic graphic in addition to a notification type of the pop-up window form.

Meanwhile, as described above, the method described in FIG. 5 can be applied to the case in which the control unit 140 senses the insertion state as well as the case in which the control unit 140 senses the insertion operation. Therefore, when the control unit 140 senses the insertion state of the E-pen 200, the display unit 110 can display the information that the E-pen 200 is in an insertion state and the user input request message for maintaining the power of the E-pen panel 114 at step 520.

For example, as shown in the upper portion of FIG. 6B, when the insertion of the E-pen 200 is completed to enter the insertion state of the E-pen 200, the display unit 110 displays an icon of the E-pen shape in the lower portion of FIG. 6B to request the input to user.

The icon shown in the lower portion of FIG. 6B informs information that the E-pen 200 is inserted to user. When touching the icon using a finger or another E-pen, the control unit 140 controls to display a notification window including a menu for controlling the power of the E-pen panel 114 or a second E-pen usage menu on the display unit 110. The user selects the control menu of E-pen panel 114 to set the power operation system of E-pen panel 114 according to user definition. The control unit 140 can store a preset user definition according to the power operation scheme of E-pen panel 114. If the user does not mainly use the second E-pen, the user can set the power of E-pen panel 114 to be constantly turned off when the E-pen 200 is inserted. On the other hand, when selecting the second E-pen usage menu, the control unit 140 turns the power of E-pen panel 114 on. The control unit 140 turns the power of E-pen panel 114 on step 550.

In the case in which the control unit 140 senses the insertion operation and receives a power maintenance input of E-pen panel 114, the control unit 140 maintains the power of E-pen panel 114 in the on-state. If the user touches the icon using the finger or selects the icon using the second E-pen other than the inserted E-pen, the control unit 140 can maintain the power of E-pen panel 114. The type of user interface requesting an input to the user is not limited to the above-mentioned scheme. Therefore, various user interfaces can be applied. When the power of E-pen panel 114 is in the on-state, the E-pen panel 114 can recognize an input of the E-pen 200, such that the display unit 110 can receive a user input by executing an app associated with the E-pen panel 114 step 570. When an input work is completed, the control unit 140 determines again whether the insertion operation of the E-pen is sensed at step 510. Here, the process of determining whether the input by the E-pen 200 is completed can be added. When the control unit 140 does not sense the input by the E-pen 200 during a preset specific time, the control unit 140 determines that the input of the E-pen 200 is completed at step 580.

In this case, at step 510, the control unit 140 determines again whether the E-pen insertion operation is detected. On the other hand, when the control unit 140 receives the input by the E-pen 200 and receives the input by the E-pen 200 again within a preset time, the control unit 140 determines that the input by the E-pen is continuously received at step 570. Meanwhile, when the control unit 140 receives an input that does not maintain the power of E-pen from the user at step 530, the power of E-pen panel 114 is turned off at step 540. When the information that does not maintain the power of E-pen is received from the user in response to the input request for maintaining the power of E-pen panel 114 after insertion of the E-pen 200, the control unit 140 panels the power supplied to the E-pen panel 114. When the power of the E-pen panel 114 is in the off state, the method reducing power consumption ends at step 560. Next, it will be described that the control unit 140 does not sense the insertion operation of the E-pen 200 at step 510. This corresponds to the case in which the control unit 140 senses the detachment operation of the E-pen 200 or the detachment state of the E-pen 200. That is, when the operation sensor 131 detects that the E-pen 200 is being detached from the E-pen insertion unit 140 or is in the detached state to convert into the electric signal and transmits the signal to the control unit 140, the control unit 140 analyzes the electric signal to sense the detachment operation or detachment state of the E-pen 200. Then, the control unit 140 turns the power of the E-pen panel 114 on at step 550. That is, the control unit 140 recognizes that the E-pen detachment is to use the E-pen input scheme, thereby, turning the power of E-pen panel 1140 on. A description of step 570 and step 580 after step 550 is identical with the above description.

As set forth above, the power of the E-pen panel can be controlled depending on whether the E-pen is used, such that the problem of power consumption continuously supplied to the E-pen panel may be solved.

In addition, according to the present disclosure, an effective usage time of the battery is increased, such that the present disclosure may provide an advantageous effect in a product usage time and exert influence on the selection of the product to provide incentives to a product provider in the sale of the product.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for detecting insertion and/or detachment of E-pen, the apparatus comprising:
a display unit including a touch screen panel (TSP) unit and an E-pen panel sensing input through the E-pen;
an E-pen insertion unit configured to detect insertion and/or detachment of the E-pen; and
a control unit configured to control power of the E-pen panel based on detection of the insertion and/or detachment.

2. The apparatus of claim 1, wherein the E-pen insertion unit includes an operation sensor configured to generate operation signal by sensing an insertion or detachment operation of the E-pen.

3. The apparatus of claim 2, wherein the operation sensor is configured to sense the operation of the E-pen using at least one magnetic field sensor.

4. The apparatus of claim 2, wherein the E-pen insertion unit further includes a state sensor configured to generate state information by sensing the insertion or detachment state of the E-pen.

5. The apparatus of claim 2, wherein the control unit is configured to turn on a power of the E-pen panel when the E-pen is detached.

6. The apparatus of claim 2, wherein when the E-pen has been inserted, the control unit is configured to display a notification requesting an input for maintaining the power of the E-pen panel together with a notification of insertion state on the display unit, and turn off the power of the E-pen panel in the case unless input for maintaining the power has been received.

7. The apparatus of claim 3, wherein the control unit is configured to display a notification requesting an input for maintaining the power of the E-pen panel together with a notification of insertion state on the display unit, and turn on the power of the E-pen panel when the input for maintaining the power is received.

8. An E-pen attachable to an apparatus for detecting insertion and/or detachment of the E-pen, the E-pen comprising:
an contact operation generating unit configured to generate a magnetic field signal sensed by a operation sensor of the apparatus, sensing an insertion/detachment operation of the E-pen.

9. A method of reducing a power consumption using a structure for detecting insertion and/or detachment of E-pen, the method comprising:
sensing an insertion and/or detachment operation of an E-pen;
determining whether the sensed operation is an insertion operation or detachment operation of the E-pen; and
controlling power of the E-pen panel according to a result of the determination.

10. The method of claim 9, wherein either one of the E-pen and an E-pen insertion unit includes a magnet, and the other one is configured to recognize a magnetic field

11. The method of claim 9, further comprising sensing an insertion and/or detachment state of the E-pen.

12. The method of claim 9, further comprising turning the power of the E-pen panel on when the detachment operation of the E-pen is detected.

13. The method of claim 9, further comprising turning the power of the E-pen panel off when the insertion operation of the E-pen is detected.

14. The method of claim 9, further comprising:
when the sensed operation is the insertion operation of the E-pen,
displaying a notification requesting an input for maintaining the power of the E-pen panel together with a notification of insertion state; and
turning off the power of the E-pen panel unless the input for maintaining the power has been received.

15. The method of claim 9, further comprising:
when the sensed operation is the insertion operation of the E-pen,
displaying a notification requesting an input for maintaining the power of the E-pen panel together with notification of an insertion state; and
turning on the power of the E-pen panel if the input for maintaining the power has been received.
